(19) United States
(12) Patent Application Publication
(10) Pub. No.: US 2018/0123991 A1
(43) Pub. Date: May 3, 2018

(54) MOBILE DEVICE AND INSTANT MESSAGING RECORD OPERATING METHOD THEREOF

(71) Applicant: Institute For Information Industry, Taipei (TW)

(72) Inventors: Yi-Chang TSAI, Taipei City (TW); Yi-Chin LEE, New Taipei City (TW)

(21) Appl. No.: 15/364,041

(22) Filed: Nov. 29, 2016

(30) Foreign Application Priority Data
Nov. 2, 2016 (TW) 105135501

(51) Int. Cl. H04L 12/58

(52) U.S. Cl. CPC H04L 51/12; H04L 51/04

(57) ABSTRACT

A mobile device and an instant messaging record operating method thereof are provided. The mobile device receives an identifying input from a user while instant messaging software is operating. The mobile device generates an operating command according to the identifying input and performs one of a hiding operation and a displaying operation on a contact record.

### PRIORITY This application claims priority to Taiwan Patent Application No. 105135501 filed on Nov. 2, 2016, which are hereby incorporated by reference in its entirety.

### FIELD

The present invention relates to a mobile device and an instant messaging record operating method thereof; and more particularly, the mobile device and the instant messaging record operating method thereof according to the present invention perform a hiding operation or a displaying operation on a specific contact record via an identifying input.

### BACKGROUND

With widespread use of networks, instant messaging software in the conventional communication technologies has become indispensable communication tools in general people's daily life. The instant messaging software accomplishes fast communication between individuals mainly through instant message transmission. To cater for users' demands for communication privacy, most of instant messaging software has a function of hiding/displaying contact or communication records.

However, the privacy operation function of the conventional instant messaging software has to perform the hiding/displaying operation for different contacts or different communication records one by one in a cumbersome way, and moreover, anyone who has the mobile device in hand can easily view the hidden contact list and associated communication records in the menu. This greatly degrades the operational convenience and the privacy level.

Accordingly, efforts have to be made in the art to improve the operational convenience and the privacy level associated with privacy operations of the instant messaging software.

### SUMMARY

The disclosure includes an instant messaging record operating method for a mobile device, which can include the steps: (a) enabling the mobile device to receive an identifying input from a user while instant messaging software is operating; (b) enabling the mobile device to generate an operating command according to the identifying input; and (c) enabling the mobile device to perform one of a hiding operation and a displaying operation on a contact record according to the operating command

The disclosure also includes a mobile device, which comprises a processing unit and an input unit. The processing unit can be configured to operate instant messaging software. The input unit is electrically connected to the processing unit and configured to receive an identifying input from a user while the instant messaging software is operating. The processing unit is further configured to: generate an operating command according to the identifying input; and perform one of a hiding operation and a displaying operation on a contact record according to the operating command

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a block diagram of a mobile device according to a first embodiment of the present invention;

FIG. 1B is a schematic view illustrating operations of the mobile device according to the first embodiment of the present invention;

FIG. 2A is a block diagram of a mobile device according to a second embodiment of the present invention;

FIGS. 2B-2E are schematic view illustrating operations of the mobile device according to the second embodiment of the present invention;

FIG. 3 is a flowchart diagram of an instant messaging record operating method according to a third embodiment of the present invention; and

FIGS. 4A-4B are flowchart diagrams of an instant messaging record operating method according to a fourth embodiment of the present invention.

### DETAILED DESCRIPTION

In the following description, the present invention will be explained with reference to certain example embodiments thereof. It shall be appreciated that, these example embodiments are not intended to limit the present invention to any specific examples, embodiments, environment, applications or particular implementations described in these example embodiments. Therefore, description of these example embodiments is only for purpose of illustration rather than to limit the present invention, and the scope of this application shall be governed by the claims.

In the following example embodiments and the attached drawings, elements unrelated to the present invention are omitted from depiction; and dimensional relationships among individual elements in the attached drawings are illustrated only for ease of understanding, but not to limit the actual scale.

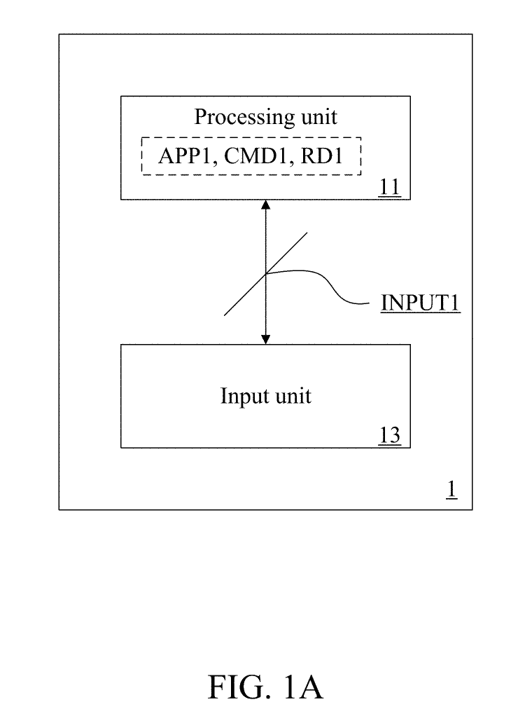

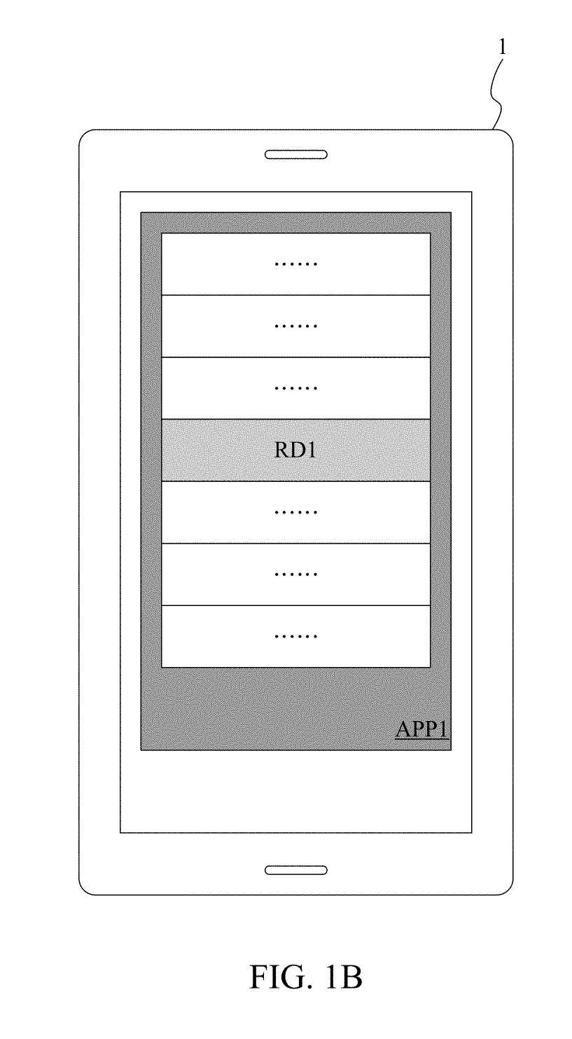

Please refer to FIGS. 1A-1B. FIG. 1A is a block diagram of a mobile device 1 according to a first embodiment of the present invention. The mobile device 1 comprises a processing unit 11 and an input unit 13. The input unit 13 is electrically connected to the processing unit 11. FIG. 1B is a schematic view illustrating operations of the mobile device 1 according to the first embodiment of the present invention. Detailed operations of the mobile device 1 will be further described hereinbelow.

First, the processing unit 11 of the mobile device 1 runs instant communication software APP1, which means that the mobile device 1 is in a state of running the instant communication software APP1. In other words, the user interface currently operated on the mobile device 1 is a user interface of the instant communication software APP1.

Then, the input unit 13 of the mobile device 1 receives an identifying input INPUT1 from a user (not shown) while the instant communication software APP1 is operating. In other words, as shown, the user inputs the identifying input INPUT1 in the user interface of the instant communication software APP1.

Afterwards, the processing unit 11 of the mobile device 1 generates an operating command CMD1 according to contents of the identifying input INPUT1, and performs one of a hiding operation and the displaying operation on a corresponding contact record RD1 according to the operating command CMD1.

In detail, if the processing unit 11 determines that the operating command CMD1 corresponding to the identifying input INPUT1 is configured to hide the contact record RD1, then the processing unit 11 performs the hiding operation on the contact record RD1. On the other hand, if the processing unit 11 determines that the operating command CMD1 corresponding to the identifying input INPUT1 is configured to display the contact record RD1, then the processing unit 11 performs the displaying operation on the contact record RD1.

It shall be particularly appreciated that, if the contact record RD1 is originally in a displayed state but the operating command CMD1 corresponding to the identifying input INPUT1 is configured to hide the contact record RD1, then the contact record RD1 changes from the displayed state into the hidden state. If the contact record RD1 is originally in the hidden state and the operating command CMD1 corresponding to the identifying input INPUT1 is configured to hide the contact record RD1, then the contact record RD1 will stay in the hidden state.

Similarly, if the contact record RD1 is originally in a hidden state but the operating command CMD1 corresponding to the identifying input INPUT1 is configured to display the contact record RD1, then the contact record RD1 changes from the hidden state into the displayed state. If the contact record RD1 is originally in the displayed state and the operating command CMD1 corresponding to the identifying input INPUT1 is configured to display the contact record RD1, then the contact record RD1 will stay in the displayed state.

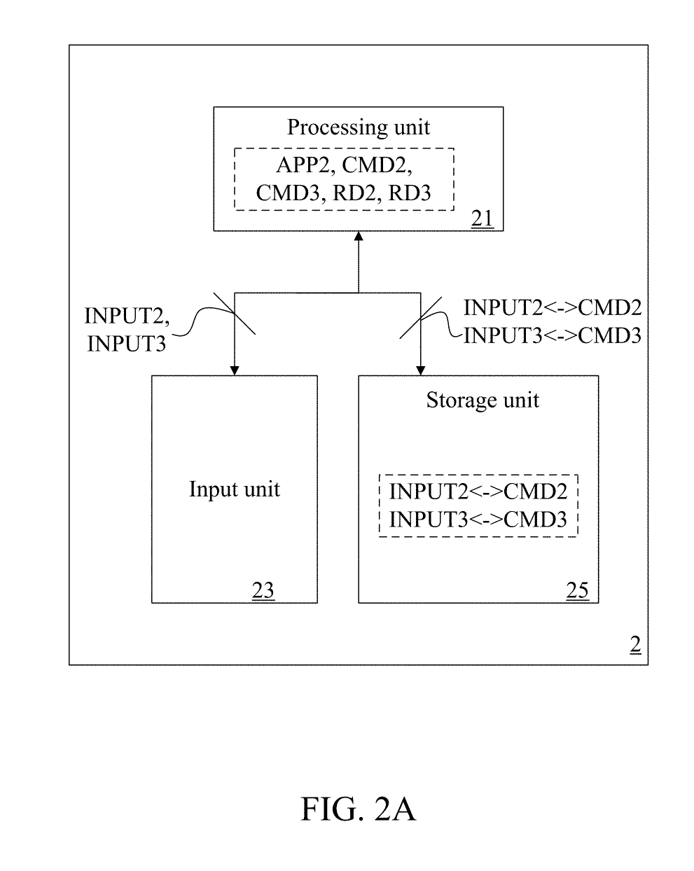

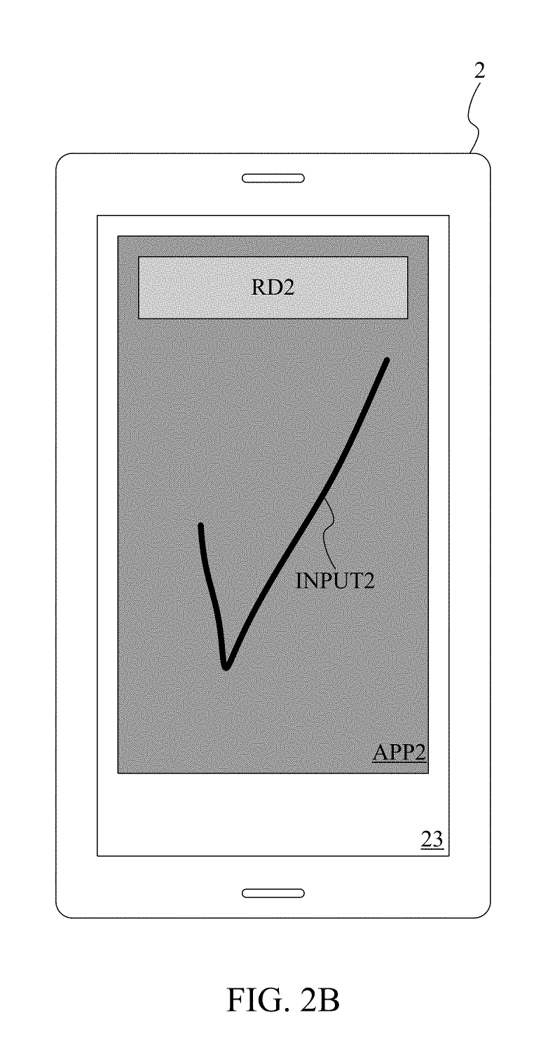

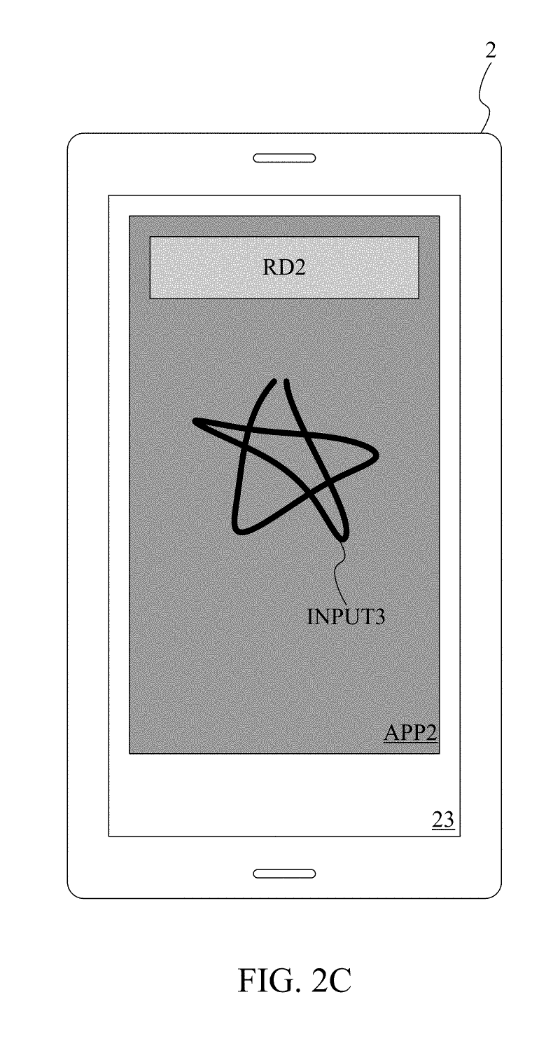

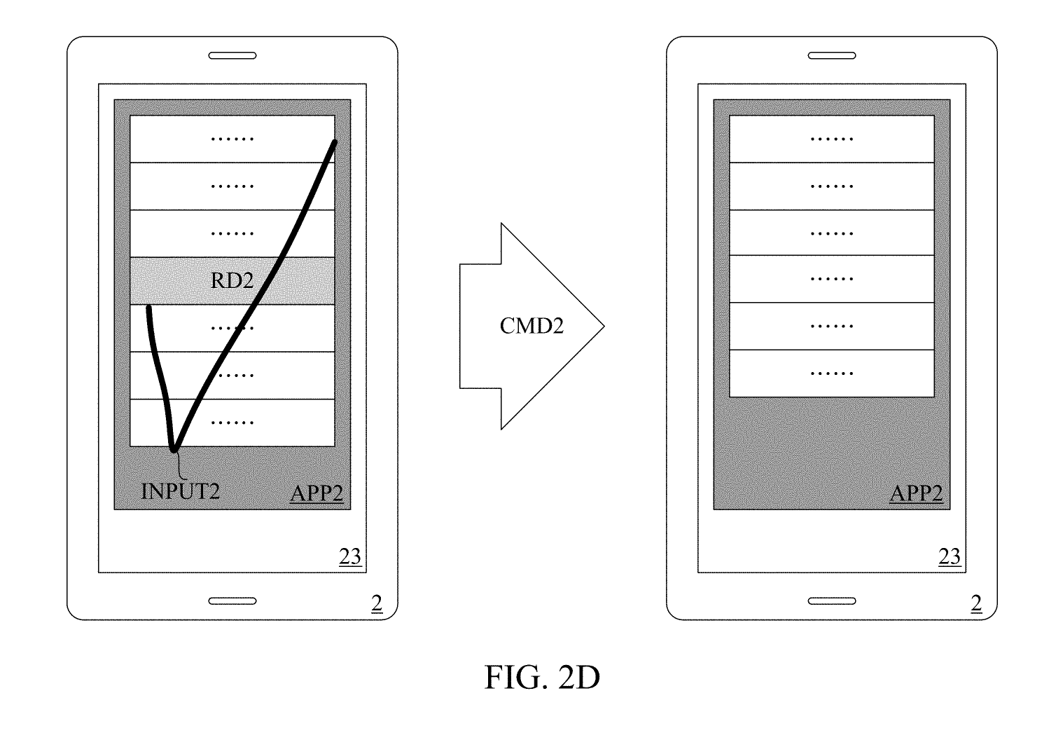

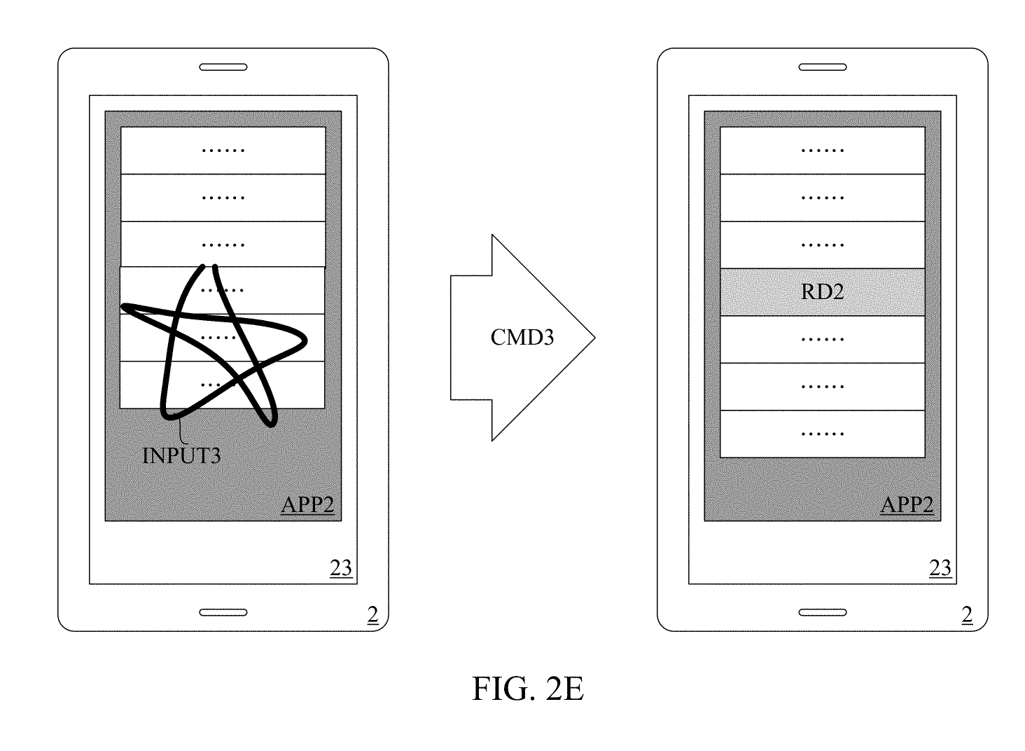

Please refer to FIGS. 2A-2E. FIG. 2A is a block diagram of a mobile device 2 according to a second embodiment of the present invention. The mobile device 2 comprises a processing unit 21, an input unit 23 and a storage unit 25. The processing unit 21, the input unit 23 and the storage unit 25 are electrically connected to each other. FIGS. 2B-2E are schematic view illustrating operations of the mobile device 2 according to the second embodiment of the present invention. It shall be appreciated that, the input unit 23 is primarily a touch screen in the input unit 23.

In the second embodiment, the user may first perform a corresponding operation setting on the specific contact data via the mobile device 2. Specifically, the user may first input an identifying input INPUT2 for a contact data RD2 via the input unit 23 of the mobile device 2. As shown in FIG. 2B, the identifying input 2 is a touch gesture input. The identifying input INPUT2 corresponds to an operating command CMD2, which is a data hiding command mainly configured to perform a hiding operation on the contact data RD2. A correspondence relationship between the identifying input INPUT2 and the operating command CMD2 is stored in the storage unit 25.

On the other hand, the user may first input an identifying input INPUT3 for the contact data RD2 via the input unit 23 of the mobile device 2. Similarly, as shown in FIG. 2C, the identifying unit INPUT3 is also a touch gesture input. The identifying input INPUT3 corresponds to an operating command CMD3, which is a data displaying command mainly configured to perform a displaying operation on the contact data RD2. A correspondence relationship between the identifying input INPUT3 and the operating command CMD3 is stored in the storage unit 25.

Next, operations in use will be performed. In detail, the processing unit 21 of the mobile device 2 runs instant messaging software APP2, which means that the mobile device 2 is in a state of running the instant messaging software APP2. In other words, the user interface currently operated on the mobile device 2 is a user interface of the instant communication software APP2.

Please refer to FIG. 2D together. When the identifying input INPUT2 from the user is received by the input unit 23 of the mobile device 2 in a state of running the instant messaging software APP2 (i.e., when the user inputs the identifying input INPUT2 in the user interface of the instant messaging software APP2), the processing unit 21 of the mobile device 2 generates the operating command CMD2 according to the identifying input INPUT2 and the correspondence relationship stored in the storage unit 25 and performs a hiding operation on the corresponding contact record RD2 according to the operation command CMD2.

On the other hand, please refer to FIG. 2E together. When the identifying input INPUT3 from the user is received by the input unit 23 of the mobile device 2 in a state of running the instant messaging software APP2 (i.e., when the user inputs the identifying input INPUT3 in the user interface of the instant messaging software APP2), the processing unit 21 of the mobile device 2 generates the operating command CMD3 according to the identifying input INPUT3 and the correspondence relationship stored in the storage unit 25 and performs a displaying operation on the corresponding contact record RD2 according to the operation command CMD3.

It shall be particularly appreciated that, the contact record RD2 may comprise contact information and session information associated with the contact information. For example, the contact record RD2 may be a contact item of the contact Wang Daming, and may also comprise session records associated with Wang Daming (personal session records or session records of a group including Wang Daming)

Accordingly, when a hiding operation is performed on the contact record RD2, the contact item of Wang Daming and session records associated with Wang Daming (personal session records or session records of a group including Wang Daming) will all be hidden. Similarly, when a displaying operation is performed on the contact record RD2, the contact item of Wang Daming and session records associated with Wang Daming (personal session records or session records of a group including Wang Daming) will all be displayed.

Further, it may be preset in the second embodiment that the corresponding operation setting on the specific contact data is performed in the user interface of the instant messaging software APP2 that is displaying the specific contact data. For example, the user may perform the operation setting of hiding/displaying in the user interface that is displaying information of Wang Darning when the instant messaging software APP2 is displaying the contact Wang Daming

Then, data associated with the contact Wang Daming being hidden represents that both the data associated with Wang Daming and the interface displaying the contact Wang Darning can be hidden so that even if other users have this mobile device in hand, the hidden data can still not be revealed through any menu interface unless the identifying input is input by the user.

In other implementations, the input unit 21 may be a biometric identifying unit (e.g., a fingerprint sensor), and the identifying input may be a biometric identifying input (e.g., a fingerprint) from the user. For example, the user may take the fingerprint of the thumb of the right hand as the identifying input for hiding a contact record, and take the fingerprint of the index finger of the left hand as the identifying input for displaying the contact record.

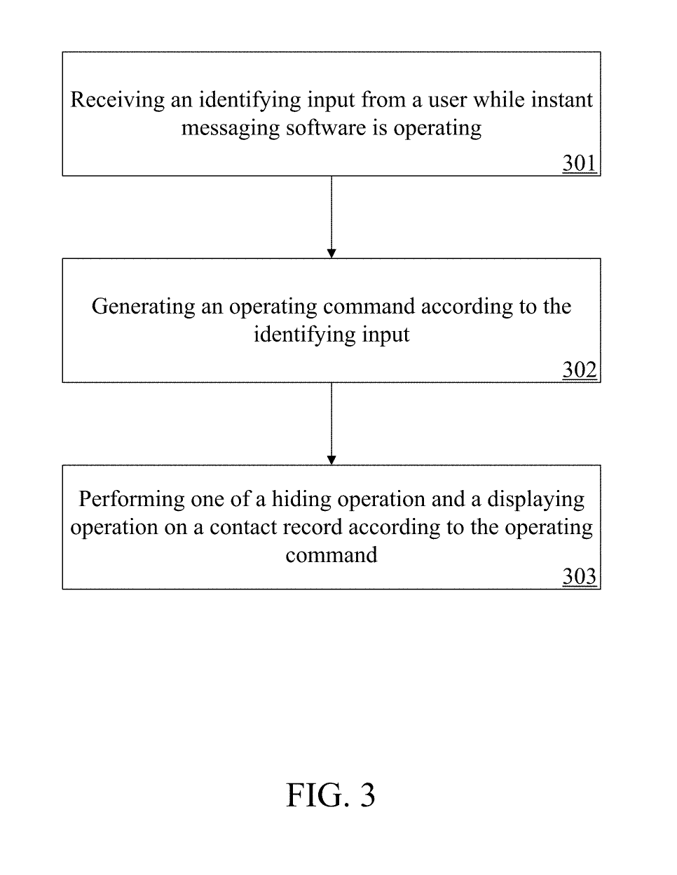

A third embodiment of the present invention is an instant messaging record operating method, a flowchart diagram of which is shown in FIG. 3. The method of the third embodiment is for use in a mobile device (e.g., either of the mobile devices described in the aforesaid embodiments). Steps of the third embodiment are detailed as follows.

First, step 301 is executed to enable the mobile device to receive an identifying input from a user while instant messaging software is operating. Step 302 is executed to enable the mobile device to generate an operating command according to the identifying input. Step 303 is executed to enable the mobile device to perform one of a hiding operation and a displaying operation on a contact record according to the operating command.

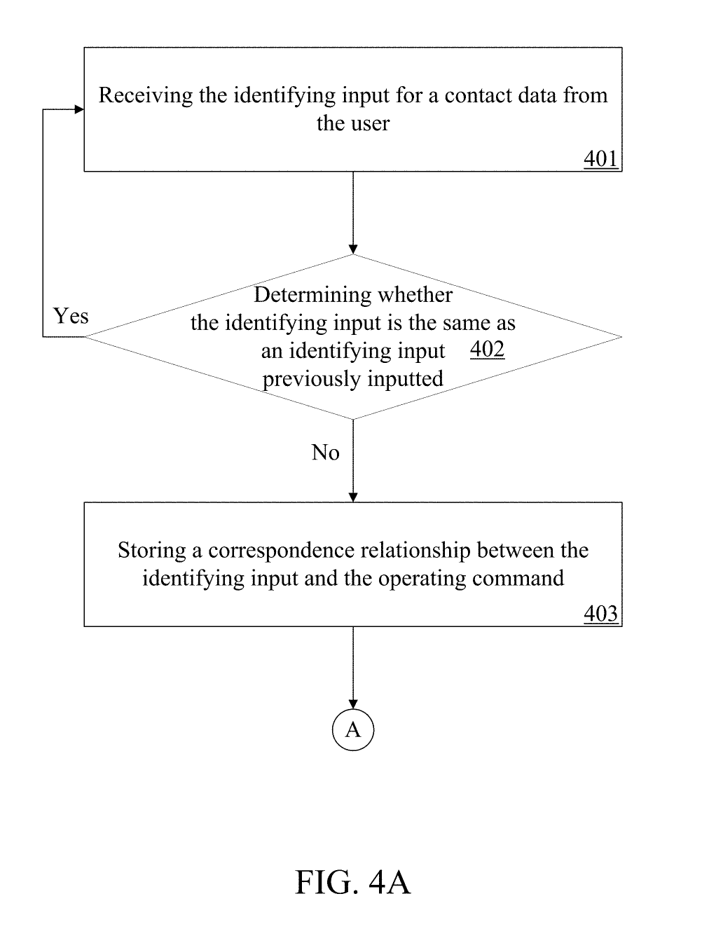

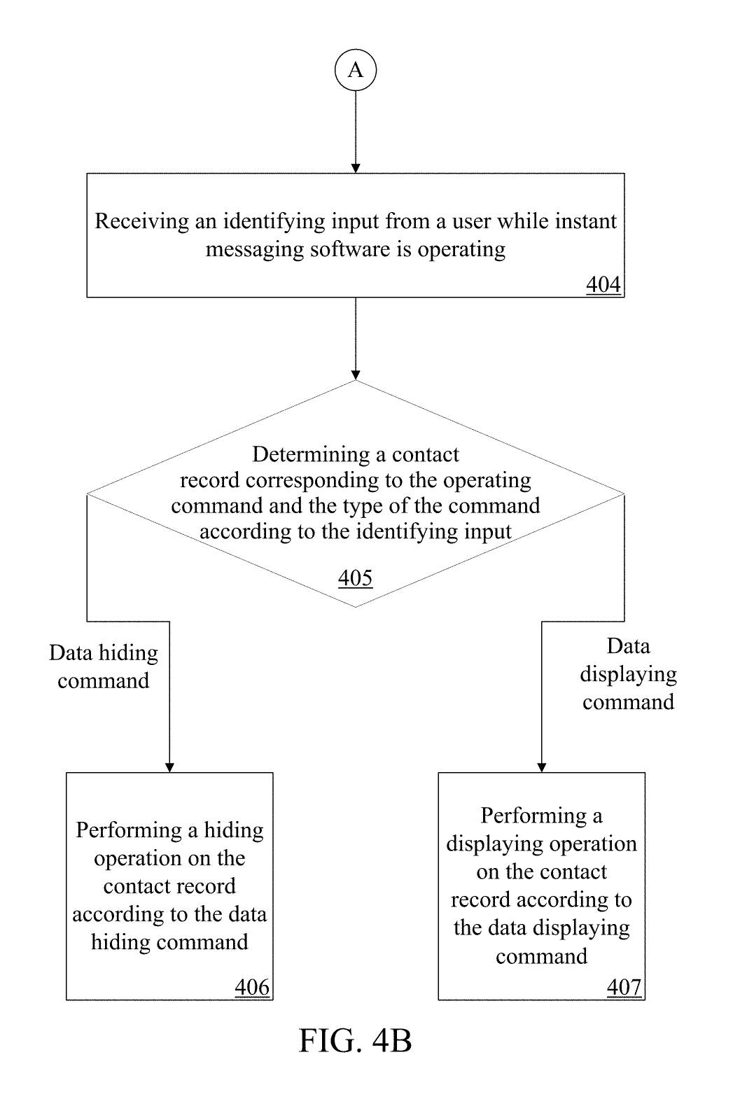

A fourth embodiment of the present invention is an instant messaging record operating method, a flowchart diagram of which is shown in FIGS. 4A-4B. The method of the fourth embodiment is for use in a mobile device (e.g., either of the mobile devices described in the aforesaid embodiments). Steps of the fourth embodiment are detailed as follows.

First, step 401 is executed to enable the mobile device to receive the identifying input for a contact data from the user. Step 402 is executed to enable the mobile device to determine whether the identifying input is the same as an identifying input previously inputted. If the answer is “yes”, then the user is prompted to make an input again to repeat the step 401, and otherwise, step 403 is executed to enable the mobile device to store a correspondence relationship between the identifying input and the operating command

Subsequently, step 404 is executed to enable the mobile device to receive an identifying input from a user while instant messaging software is operating. Step 405 is executed to enable the mobile device to determine a contact record corresponding to the operating command and the type of the command according to the identifying input.

If the operating command is a data hiding command, then step 406 is executed to enable the mobile device to perform a hiding operation on the contact record according to the data hiding command If the operating command is a data displaying command, then step 407 is executed to enable the mobile device to perform a displaying operation on the contact record according to the data displaying command.

Similar to the previous embodiment, the identifying input may be a touch gesture input or a biometric identifying input from the user in the fourth embodiment. The contact record may comprise contact information and session information associated with the contact information. Also similarly, it may be preset that the corresponding operation setting for the specific contact data is performed in a user interface of the instant messaging software that is displaying the specific contact data.

Then, data associated with the contact being hidden represents that both the data associated with the contact and the interface displaying the contact can be hidden so that even if other users have this mobile device in hand, the hidden data can still not be revealed through any menu interface unless the identifying input is input by the user.

According to the above descriptions, the mobile device and the instant messaging record operating method thereof according to the present invention primarily perform the operation setting of hiding/displaying through different identifying inputs (e.g., a touch gesture input or a biometric identifying input) in a user interface displaying the specific contact information. This not only improves the convenience of operations associated with the privacy, but also hides the setting interface together to greatly improve the privacy level of the data operations.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An instant messaging record operating method for a mobile device, comprising:
(a) the mobile device receiving an identifying input from a user while instant messaging software is operating;
(b) the mobile device generating an operating command according to the identifying input; and
(c) the mobile device performing one of a hiding operation and a displaying operation on a contact record according to the operating command

2. The instant messaging record operating method according to claim 1, wherein the identifying input is a touch gesture input of the user.

3. The instant messaging record operating method according to claim 1, wherein the identifying input is a biometric identifying input of the user.

4. The instant messaging record operating method according to claim 1, wherein the contact record comprises contact information and session information associated with the contact information.

5. The instant messaging record operating method according to claim 1, wherein the operating command is a data hiding command, and the step (C) further comprises:
(c1) the mobile device performing a hiding operation on the contact record according to the data hiding command.

6. The instant messaging record operating method according to claim 1, wherein the operating command is a data displaying command, and the step (C) further comprises:
(c1) the mobile device performing a displaying operation on the contact record according to the data displaying command.

7. The instant messaging record operating method according to claim 1, further comprising the following before the step (a):
(a1) the mobile device receiving the identifying input for the contact record from the user; and
(a2) the mobile device storing a correspondence relationship between the identifying input and the operating command.

8. A mobile device, comprising:
a processing unit, being configured to operate instant messaging software;
an input unit electrically connected to the processing unit, being configured to receive an identifying input from a user while the instant messaging software is operating;
wherein the processing unit is further configured to:
generate an operating command according to the identifying input; and
perform one of a hiding operation and a displaying operation on a contact record according to the operating command.

9. The mobile device according to claim 8, wherein the input unit is a touch screen, and the identifying input is a touch gesture input of the user.

10. The mobile device according to claim 8, wherein the input unit is a biometric identifying unit, and the identifying input is a biometric identifying input of the user.

11. The mobile device according to claim 8, wherein the contact record comprises contact information and session information associated with the contact information.

12. The mobile device according to claim 8, wherein the operating command is a data hiding command, and the processing unit is further configured to:
perform a hiding operation on the contact record according to the data hiding command

13. The mobile device according to claim 8, wherein the operating command is a data displaying command, and the processing unit is further configured to:
perform a displaying operation on the contact record according to the data displaying command

14. The mobile device according to claim 8, further comprising a storage unit electrically connected to the processing unit and configured to store a correspondence relationship between the identifying input and the operating command
